(19) United States
(12) Patent Application Publication
(10) Pub. No.: US 2020/0110687 A1
(43) Pub. Date: Apr. 9, 2020

(54) DIFFERENTIAL RESOURCE PROFILING WITH ACTIONABLE DIAGNOSTICS

(71) Applicant: Mobile Enerlytics LLC, West Lafayette, IN (US)

(72) Inventors: Yu Charlie Hu, West Lafayette, IN (US); Abhilash Jindal, San Francisco, CA (US)

(21) Appl. No.: 16/595,321

(22) Filed: Oct. 7, 2019

Related U.S. Application Data
(60) Provisional application No. 62/741,920, filed on Oct. 5, 2018.

(51) Int. Cl. G06F 11/30; G06F 1/3203

(52) U.S. Cl. CPC G06F 11/3062; G06F 1/3203; G06F 11/3051; G06F 11/3013

(57) ABSTRACT

A differential resource analyzer performs differential resource profiling of two applications. The two applications are made to perform an operation. The differential resource analyzer matches a first application task of a first application to a second application task of a second application based on a determination that the first application task is similar to the second application task, and measures resource consumed in the first application task and the second application task. Responsive to determining that the second application task consumes less resource than the first application task, the differential resource analyzer performs an action to reduce resource consumption by the first application based on the second application task.

### CROSS-REFERENCE TO RELATED APPLICATION

This application claims the benefit of U.S. Provisional Patent Application No. 62/741,920, filed Oct. 5, 2018, which is incorporated herein by reference in its entirety.

### TECHNICAL FIELD

The disclosed teachings generally relate to profiling resource consumption by mobile applications (“apps”).

### BACKGROUND

Despite the prevalence of smartphones, user experience has remained severely limited by their resource constraints. As such, mobile platform vendors such as APPLE and GOOGLE have taken initiatives encouraging app developers to design apps for reduced energy consumption, processing resources, or memory usage. The typical development cycle for optimizing resource consumption of mobile apps is similar to that for optimizing the running time of software. For example, to reduce energy usage, a developer manually iterates the process of (1) finding hotspots in app source code that contribute to a significant cause of the total app energy drain, and then (2) determining whether and how the energy hotspots can be restructured to drain less energy.

However, mobile apps are highly complex, easily consisting of millions of lines of source code involving third-party software interacting with operating systems (OS's) provided framework in complex ways. Without the help of automatic tools, even detecting energy hotspots in app source code by developers is prohibitively challenging, and even more prohibitive to determine whether and how to reduce overall resource consumption.

### BRIEF DESCRIPTION OF THE DRAWINGS AND TABLES

FIG. 1 is a block diagram of an example mobile device 110.

FIG. 2A illustrates an example of a pairwise overlap of similar music streaming apps.

FIG. 2B illustrates an example of a pairwise overlap of similar cleaning apps.

FIG. 2C illustrates an example of a pairwise overlap of similar email apps.

FIG. 2D illustrates an example of a pairwise overlap of similar launcher apps.

FIG. 2E is a table showing example percentages of total energy expenditure that can be attributed to framework methods.

FIG. 3 illustrates an example call tree for a software application.

FIG. 4A illustrates an example of a call tree structure.

FIG. 4B illustrates an example of a dynamic call graph (DCG) structure.

FIG. 4C is a table showing example percentages of total energy expenditure that can be attributed to framework methods.

FIG. 5 illustrates nodes in a candidate set Cα (v).

FIG. 6 illustrates a namespace problem.

FIG. 7 illustrates a hierarchy problem.

FIG. 8 is a flowchart illustrating a process for evaluating and improving app energy usage, according to some embodiments.

FIG. 9 is a table showing an example application comparison.

FIG. 10 is a table showing an example application comparison.

FIG. 11 is a table showing an example application comparison.

FIG. 12 is a table showing an example application comparison.

FIG. 13 illustrates an example of matched tasks between different apps.

FIG. 14 is a block diagram illustrating an example computing device in which aspects of the disclosed technology can be embodied.

The drawings and tables depict various embodiments for illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

The description set forth below represent the necessary information to enable those skilled in the art to practice the embodiments and illustrate the best mode of practicing the embodiments. Upon reading the following description in light of the accompanying figures and tables, those skilled in the art will understand the concepts of the disclosure and will recognize applications of these concepts that are not particularly addressed herein. It should be understood that these concepts and applications fall within the scope of the disclosure and the accompanying embodiments.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

### 1. Introduction

Many mobile devices, such as smartphones or tablets, execute mobile applications (“apps”) written by third party developers. The apps use resources available on the mobile device, such as power, processing resources, and memory. For example, as the device executes an app, the processing, display, and other system resources used by the app draw power from a battery in the mobile device. Different components of each app may draw different amounts of power. Energy diagnostic tools such as a mobile application energy profiler can identify energy hotspots in source code for the app. That is, they only tackle the first challenge faced by developers to identify potential energy hotspots in source code. After identifying the energy hotspots, developers are not given any guidance on how to proceed with an optimization process including, for example, (1) whether a more energy-efficient implementation for the same app task exists and (2) how to develop the more energy-efficient implementation. Similar problems exist for optimizing other resources used by mobile apps.

To overcome these drawbacks, the disclosed embodiments include resource profiling technology (also referred to as “differential resource profiling” or “resource diffing”) which can automatically determine more efficient implementations of app tasks by leveraging existing implementations of similar apps which are available from online app stores. As such, the disclosed technology can (1) determine whether a resource-intensive code segment can be optimized and (2) suggest how to optimize an app to conserve mobile device resources.

Various embodiments of the resource profiling technology set forth herein are described by way of example with respect to energy usage. However, the techniques and tools described herein can instead be used to reduce the amount of other computing resources that a mobile app uses, including processing resources and memory utilization.

### 1.1. Conceptual Overview

An underlying concept of differential resource profiling is identifying similar apps by different developers that implement similar or identical app tasks. Chances are that the implementations differ and, as a result, will have different resource footprints. Thus, comparing source-code resource profiles generated by a resource profiler for app tasks can expose the more efficient implementation for the same app tasks from among a group.

In this disclosure, three observations about the uniqueness of the mobile app stores and common mobile app development practices are made. First, because of low barriers to app development, there are typically a few dozen competing apps that implement similar or identical app functions or app features for every popular app in the app market. Second, selected app groups (e.g., a number of different app categories in GOOGLE PLAY, each including another number of similar apps and different versions of the same app) can be evaluated using a resource profiler tool to determine that similar apps consumer different amounts of resources when performing similar app functions. Thirdly, mobile apps rely on the use of a common framework of services of mobile OS's (e.g., the ANDROID framework), and a profiling analysis of the selected app groups would show similar apps in each group that share the same framework method calls and spend a large proportion of their app resource consumption in calling framework services. For example, each group may share 38.6% to 81.9% of the same framework method calls and spent 44.0% to 96.7% of their app energy drain in calling framework services.

The first and second observations suggest that it is possible to determine a more efficient implementation of the same app task by comparing resource profiles of similar apps. However, if apps have very different source code structures, such comparison may not be effective. The third observation affirms that such comparisons of similar apps is meaningful and potentially effective at diagnosing and improving app design to reduce resource utilization.

This disclosure describes an embodiment of a design and implementation of a differential (“diffing”) resource profiler referred to as DIFFPROF 148. The development of a diffing resource profiler faces challenges including determining (1) granularity for diffing; (2) how to identify diffing units for the source-code resource profiler output of each app; and (3) how to diff resource profiles of similar apps. These items are addressed as following.

With respect to the granularity for diffing, app tasks can be used as the diffing granularity. In light of modular programming principles, an app is structured to implement a number of app features or tasks. Because a goal of resource diffing is to determine more efficient implementations of app tasks, the diffing granularity that directly helps make this determination by developers is an app task.

With respect to identifying diffing units, this can be achieved by characterizing how app tasks manifest as call trees. Specifically, diffing at the app-task granularity level requires identifying app tasks in call trees output by a source-code resource profiler. To address this challenge, call trees of top apps can be examined. In some embodiments, app tasks manifest themselves as Erlenmeyer flask-shaped representations (“EFLASKS 320”) in tuples of <call path, framework-method, subtree> where the call path identifies the context of a task, the framework-method is used to invoke the framework service to accomplish the task, and the subtree indicates the particular execution of the framework service.

With respect to diffing resource profiles of similar apps, an EFLASK 320 matching algorithm can be used to diff resource profiles of similar apps. Insights are described herein on how and why different implementations (EFLASKS 320) of the same app task differ, which motivates the need for EFLASK 320 matching. An embodiment of the EFLASK 320 matching algorithm can accurately find similar EFLASKS 320 corresponding to the same app task.

Embodiments of a differential resource profiler as described herein can accurately identify matched tasks that account for most (e.g., 79%) of total average energy drain by mobile apps, as well as unique tasks (e.g., 21% of total average energy) in similar apps. Various embodiments can also determine whether and how resource-intensive portions of app source code can be improved by identifying and comparing different implementations of the same task in similar apps.

The disclosure includes case studies to show that a differential resource profiler can provide developers with actionable diagnoses to reduce energy consumption by their apps. These actionable diagnoses can include, for example, identifying known inefficient tasks or outputting more efficient implementations for an app's source code, which allows developers to readily understand reasons for energy differences between similar apps with minor debugging efforts (e.g., setting breakpoints) since the developer did not author the similar app. For example, of twelve inefficient or buggy implementations in nine apps, three of which have been confirmed by developers, updating those implementations reduces app energy drain by 5.2%-27.4%. Similar benefits can be achieved by using the differential resource profiler to analyze an app's impact on other mobile device computing resources.

### 1.2. System Overview

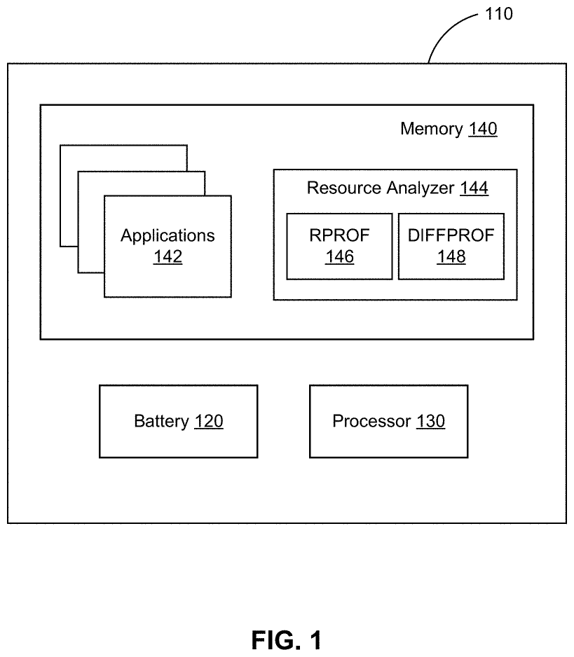

FIG. 1 is a block diagram of an example mobile device 110, which in some embodiments can be used to implement systems and processes described herein. As shown in FIG. 1, the mobile device 110 includes a battery 120, a processor 130, and a memory 140. The mobile device 110 can include additional components not shown in FIG. 1. The mobile device 110 can execute an operating system, such as APPLE iOS or GOOGLE ANDROID. Although embodiments are described herein with respect to the mobile device 110, in other embodiments the mobile device can be replaced with any of a variety of computing devices. Thus, for example, various systems and processes described herein may be implemented by a mobile device such as a mobile phone or tablet computer, or by other computing devices such as a laptop computer, a desktop computer, a smart television, a set-top box, a server, or a distributed computing system that includes one or more computing devices.

The battery 120 supplies power to various components of the mobile device 110, including the processor 130 as well as other components such as communications circuitry, audio circuitry, or a display device.

The processor 130 can include one or more processing devices such as a central processing unit, an application specific integrated circuit (ASIC), or a field programmable gate array (FPGA). The processor 130 executes code stored by the memory 140.

The memory 140 stores computer program code that is executable by the processor 130. The memory 140 can store code corresponding to one or more applications (“apps”) 142. Depending on the language of the app, the code stored in the memory 140 can include source code, bytecode, compiled code, and/or other types of human-readable, machine-readable, or intermediate code formats. Each app 142 can include a set of functions that, when executed, together provide a service, tool, or other functionality to a user of the mobile device 110. When a developer creates an app 142, the developer may publish the app to a central repository, such as an app store, through which users of mobile devices can download any desired apps. The apps 142 can be categorized based on their functionality, for example as music streaming apps, cleaning apps, messaging apps, or shopping apps. In some embodiments, a developer of an app 142 can tag the app with an identifier of its category when the developer publishes the app to the central repository. In other cases, the app 142 can be tagged with a category identifier by users, other developers, or other third-party reviewers, or by an automated classifier.

The memory 140 can further store a resource analyzer 144 that is executable by the processor 130. The resource analyzer 144 measures and compares energy usage of the apps 142. Based on its analysis, the resource analyzer 144 can output information to reduce energy consumption of the apps 142.

The resource analyzer 144 can include a resource profiler (“RPROF 146”) 146 and a differential resource profiler tool (“DIFFPROF 148”) 148, each of which can be executed by the processor 130. In some embodiments, as shown for example in FIG. 1, RPROF 146 and DIFFPROF 148 are both executed by the mobile device 110 that also executes the applications 142. However, in other embodiments, one or both of RPROF 146 and DIFFPROF 148 may be executed by a remote computing device coupled to the mobile device 110 by wired or wireless communication, such as over a network. For example, a laptop or desktop computer may execute DIFFPROF 148 while the mobile device 110 executes RPROF 146 and the apps 142. In still other embodiments, the remote computing device can execute both RPROF 146 and DIFFPROF 148, as well as a simulation environment to simulate execution of the apps 142 on the mobile device 110.

RPROF 146 analyzes the apps 142 to determine a quantity of resources of the mobile device 110 used when each app 142 is executed. For example, RPROF 146 measures an amount of energy drawn from the battery 120 as an app 142 is executed. In some embodiments, RPROF 146 measures the energy drain by comparing a power status of the battery before and after the app 142 performs an operation. In other embodiments, RPROF 146 measures an amount of processing resources used by determining an amount of processor time used to perform methods associated with the app 142. Other resources of the device 110 can be similarly measured and compared to determine how to reduce resource utilization by the apps 142.

DIFFPROF 148 compares resource usage by the apps 142, as output by RPROF 146, to identify portions of the apps 142 that use significant resources (referred to herein as “hotspots”). When DIFFPROF 148 is executed, it can provide developers with actionable diagnosis to change or reduce the amount of resources employed by the app 142. For example, DIFFPROF 148 can identify non-essential (e.g., unmatched or extra) tasks and known inefficient (e.g., matched) tasks. Moreover, DIFFPROF 148 can extract call trees of tasks to allow developers to quickly understand reasons and fixes for the different resource utilization to reduce debugging efforts.

2. Insights from Mobile App Stores

The DIFFPROF 148 tool can be designed in light of insights made about the mobile app market. First, competing or similar apps are abundant on online app stores. Second, similar apps differ in their resource utilization (e.g., causing different energy consumption). Third, framework services may dominate app resources. These insights are examined as follow.

### 2.1. Competing/Similar Apps are Abundant

A unique phenomenon of a mobile app store is that for every popular app, there are typically a few dozen competing apps that implement similar or identical app functions or app features. Moreover, similar apps, such as two music streaming apps, typically have similar user interactions. For example, the music playback screens of all music streaming apps have an album cover image, the song and the album title, a progress bar, elapsed and remaining time text, and buttons to control music playback, and every app performs music playback.

### 2.2. Similar Apps Differ in Resource Utilization

Given the abundance of similar apps for every popular app, the resource analyzer 144 can compare two or more similar apps to analyze resource utilization by each app and output actionable insights a developer can use to reduce the amount of mobile device resources an app will use. The resource analyzer 144 can use automated tests to perform identical operations on the similar apps in each group. The energy drained by these operations can be measured by using RPROF 146. For example, the resource analyzer 144 can simulate execution of an app (e.g., using UI Automator, the ANDROID black box UI testing framework, which does not require app source code) and measure energy used during the simulation. For each group of similar apps, the resource analyzer 144 may perform a generic base test that interacts with common user interface elements. Next, for each app in a cluster, the resource analyzer 144 can launch an app either in a simulator or on the mobile device 110 and the unique IDs can be found of any user interface elements involved in the base test. Lastly, a base test can be run with app-specific user interface element IDs, thus performing homogeneous interactions across similar apps.

Different tests can be defined for each app category. For example, energy usage by music streaming apps can be compared by streaming music through each app for a length of time, such as 30 seconds. Cleaning apps can be compared by running a cleaning operation with each app, and antivirus apps can be compared by performing a security scan in each app. Email apps can be compared by composing and sending the same email in each app and sending it. The energy used by launcher applications can be compared by, for example, sliding a display screen from left to right every two seconds for 30 seconds. Instant messaging apps can be compared by sending the same number of messages (e.g., five) to a contact. Shopping apps can be compared for searching for a specified item (e.g., socks), scrolling the results page and selecting the first result. File explorer apps can be compared by, for example, scrolling a root directory in the app and creating a new directory. Other tests can be designed to compare energy usage of similar apps.

### 2.3. Framework Services Dominate App Resource Utilization

Mobile apps generally rely heavily on common framework services provided by modern mobile operating systems such as the ANDROID framework. To simplify app programming, such frameworks implement and export to apps many services that implement commonly performed tasks. For example, the ANDROID framework provides, among others, LocationManager, DownloadManager, MediaPlayer, and WindowManager. Typically, an app presents requirements via configuration parameters to the services, and the services then perform the low-level work on app's behalf. The heavy usage of framework services may lead to a high percentage of app energy drain occurring in these common services and the framework methods called in similar apps have a substantial overlap. Similarly, the framework methods may be responsible for a large percentage of other computing resources used by the apps.

Because a significant portion of an app's resource usage may be caused by the framework methods, RPROF 146 can be used to decouple the resources spent in app methods from those spent in framework services. First, RPROF 146 can identify framework packages on the mobile device 110, for example by querying framework jar files on the device. For example, in the ANDROID operating system, such framework packages may include android.view, dalvik.system and java.math. Next, for each app, all the framework methods are identified in its resource profiling output belonging to the framework packages. Finally, RPROF 146 can aggregate resource utilization of the framework packages to compute the total framework resource utilization. When energy drain of an app is analyzed, for example, any energy drain not attributable to the framework packages can be identified as energy drain unique to the app.

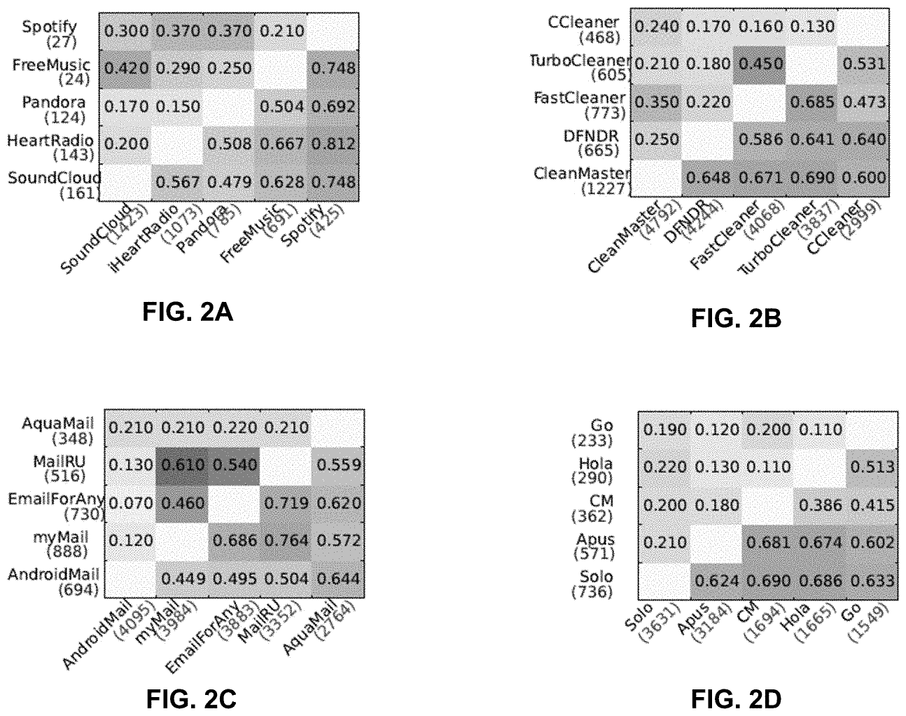

Example framework overlaps between apps in four app categories are shown in FIG. 2A-2E. Specifically, FIG. 2A shows example percentages of source code for music streaming apps that are made up of common framework apps. FIG. 2B shows example overlaps between various cleaning apps, FIG. 2C shows example overlaps between email apps, and FIG. 2D shows example overlaps between launcher apps. The examples shown in FIG. 2A-2E illustrate that apps within a given category can have significant pairwise overlap in framework methods called during a profiling run (e.g., between 38.6% and 81.9%, and 61.7% on average). Further, FIG. 2E is a table showing example percentages of total energy expenditure that can be attributed to framework methods, illustrating that a significant portion of total energy of the apps in each group can be spent in framework API calls (ranging, in the example shown in FIG. 2E, between 44.0% to 93.8% for launcher apps to between 89.3% to 94.9% for file explorer apps). In the example apps shown in FIG. 2A-2E, the heavy usage of framework services leads to a high percentage of app energy drain occurring in these shared services, up to over 90% of the app energy consumption. This indicates that determining more efficient implementations of app functions by comparing energy footprints is possible and is a meaningful and practical approach to reducing energy consumption.

### 3. How to Diff Energy Profiles

By comparing energy profiles of similar apps, the resource analyzer 144 can automatically identify inefficiencies in implementing common app functions in similar apps. This approach is referred to in this disclosure as “differential energy profiling,” or “energy diffing.” Embodiments of the differential profiler described herein address various challenges associated with energy measurement, including one or more of determining (1) a diffing granularity, (2) how to identify the diffing units in the energy profiler output of each app, or (3) how to diff the energy profiles of similar apps.

### 3.1. Diffing Granularity

A mobile app 142 may implement many features. The implementation of individual app features in the source code and their invocations at runtime are app tasks. Similar apps can implement a common set of core tasks pertaining to the apps' common, main functionality such as music playback along with some basic UI features (e.g., progress bar) for music streaming apps. In addition, similar apps by different vendors can often support some differentiating features which result in different tasks at runtime. For example, among five streaming apps, SOUNDCLOUD uniquely depicts an audio track using a waveform animation during music playback.

There are multiple potential factors that contribute to different energy drains of similar apps such that a suitable granularity for energy diffing of similar apps is an app task. The factors include (1) different implementation of common app tasks, and (2) app tasks unique to each of the similar apps.

### 3.2. App Tasks Manifested in Call Trees

To diff at the app task level, the resource analyzer 144 can identify the same app tasks in similar applications. App tasks may not be explicitly labeled by developers. Thus, the resource analyzer 144 can identify similar tasks by evaluating a structure of relationships between methods executed by two or more apps.

ANDROID app programming is event-driven, where the ANDROID framework implements frequently used tasks as services. The ANDROID framework services provide several java interfaces and classes with callback methods that apps can override. Apps then use the associated registration-callback mechanism to register the overridden callback app methods with the framework. Upon occurrence of an event, the ANDROID framework calls these overridden methods registered for the event.

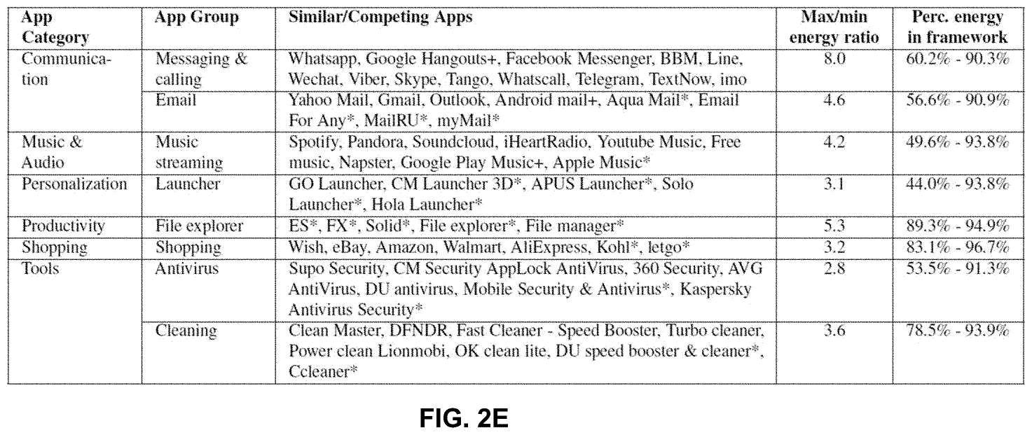

FIG. 3 illustrates an example call tree 300 associated with an app, representing methods (each represented by a node 305) called during execution of the app. ANDROID framework methods are referred to herein as F-methods, and app methods are referred to herein as A-methods. The above asynchronous programming suggests that (1) an app's energy profiling output typically has many call trees, one for each thread; (2) as shown in FIG. 3, each call tree typically starts with some framework method (F0) that receives callback related messages and makes a callback into the app (A1). The app callback method (A1) may call various other app methods (folded in A1) which later call another framework method (F2 or F3) to register more callbacks (A2) or for general processing that implements the task. The call tree 300 can also include one or more subtrees 310 called by methods in the tree, where each subtree 310 can have a structure similar to the call tree 300. Some app paths may contain only F-methods (e.g., (F0, F1)). This happens when an app task calls some framework method X that in turn registers an asynchronous callback of some other framework method Y. When framework method Y is invoked, it starts a new path off the root of the call tree consisting entirely of framework methods. Typical general-purpose framework methods that serve as roots of call trees include, for example, Handler.dispatchMessage and Binder.execTransact.

As shown in FIG. 3, the call tree structure suggests that an app task can manifest in a call tree as an Erlenmeyer flask-shaped representation (“EFLASKS”) 320 with three components. Those components include a call path, F-method, and subtree. A call path is from the root of the call tree consisting of F-methods followed by A-methods that lead to the F-method and uniquely captures the context of the task, (i.e., under which the F-method was called). A specific F-method invoked by the app method is the entry to the invoked framework service that accomplishes the app task. A subtree is the execution of the F-method, given the context and the parameters passed to the entry method. This three-component structure (i.e., call path, F-method, and subtree task tuple), defining a task in an app, is referred to herein as an EFLASK 320.

The resource analyzer 144 compares energy usage by two apps by matching a first app task (a first EFLASK) in a first app to a second app task (a second EFLASK) in a second app. The disclosed EFLASK 320 matching algorithm described in § 3.4 takes the call trees of two similar apps and identifies EFLASKS 320 corresponding to app tasks while finding matching tasks.

### 3.3. Tree Structures to Diff

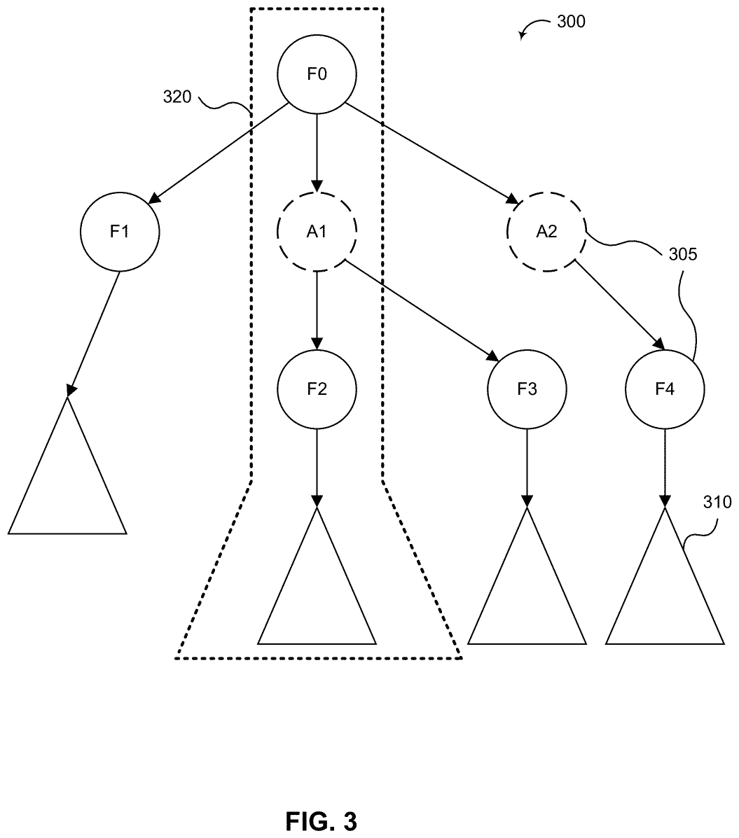

FIG. 4A-4C shows different options of tree structures to perform differential energy profiling. Specifically, FIG. 4A shows an example call tree structure 410. Because RPROF 146 will output a call tree for each execution profile, a baseline approach would be to directly diff two call trees (CT) 410. However, this may not be practical because an app task may be invoked many times during a profiling run and thus its task tuple may appear many times in a call tree output. Further, a call tree may become prohibitable large, up to several million call tree nodes in just a few minutes of a typical profiling run.

FIG. 4B shows an example dynamic call graph (DCG) structure 420. A DCG is an alternative approach to convert call trees to DCGs and diff DCGs, where every method executed has just one corresponding method node 422 in a DCG. However, using DCGs may face a challenge that a DCG is not path preserving. That is, it may contain code paths that never occurred during the profile run. For example, the DCG in FIG. 4B contains path M→A→B→D which never occurred in the CT 410 of FIG. 4A. Paths should or must be preserved for matching the EFLASKS 320 of the same app tasks.

FIG. 4C shows an example calling context tree structure 430. A calling context tree structure overcomes the above shortcomings of CT and DCG structures by building and using a calling context tree (CCT), which is a middle ground between a call tree and a dynamic call graph. In one example, two method call nodes in the call tree are merged in the CCT whenever both nodes have an identical path from a root. In addition, recursive calls are merged to the non-recursive ancestor to keep the tree bounded in size as shown in, for example, node A in FIG. 4C. Thus, using a CCT preserves the valuable path information while significantly reducing the number of nodes in the tree. In practice, CCT may contain only tens of thousands of nodes in a few minutes of a profiling run, allowing for the disclosed matching algorithm to run in less than 30 seconds (see § 5).

### 3.4. EFLASK 320 Matching

The disclosure includes techniques for matching EFLASKS 320 of the same app tasks. The EFLASK 320 matching processes described herein may be performed by the resource analyzer 144.

### 3.4.1. Approximate EFLASK 320 Matching

Due to the manner in which app task manifests in call trees, different implementations of the same task, and their corresponding EFLASK 320 structures, can differ. Thus, to match two tasks of different apps, the resource analyzer 144 identifies similar EFLASKS 320 in similar apps that implement the same common app task.

Corresponding call paths in different EFLASKS may differ slightly. This can happen for two main reasons. First, apps may use slightly different mechanisms to achieve the same app callback. For example, an app can start its Runnable.run method directly from a new thread, or via ExecutorService; the two lead to different paths from a root. Second, the app can use different app callbacks for receiving similar events. For example, the a first cleaner app may handle the “clean” button press using.onClick callback, while a second cleaner app may use .onItemClick callback after which both apps call Activity.startActivity to perform a common task.

In addition, the entry F-methods may differ due to two main reasons. First, the same task application program interface (API) can be provided by different framework classes. For example, both HttpsURLConnectionImpl.getInputStream and HttpURLConnectionImpl.getInputStream get data from a server, one from an https and another from an http connection. Second, the same framework class may provide many alternate APIs to perform the same app task. For example, three different apps, WISH, KOHL and LETGO, share eight common nodes in the call path from the root call and finally call three different APIs, ImageView.setImageDrawable, ImageView.setImageBitmap and ImageView.setImageResource, respectively, for setting an image.

The subtrees that reflect the actual executions of app task of similar apps may differ. Specifically, even when the developers use the same framework API call to accomplish a task, the program state and the call parameters passed in can differ. This leads the framework service to take different paths resulting in different subtrees.

### 3.4.2. Other Tree Matching Algorithms

In some instances, other or previous tree matching algorithms are not suitable for matching EFLASKS 320.

One technique is exact path matching. For example, let T1 and T2 be two CCTs rooted at r1 and r2, with a set of nodes denoted by V(T1) and V(T2). Formally, exact path matching produces a one-to-one node matching, M, where M⊆V(T1)×V(T2) and for any pair (v,w) ϵ {M−(r1, r2)}:(r1, r2) ϵ M and (P(v),P(w)) ϵ M (Path Condition) (Eqn. 1), where P(v) and P(w) are parents of nodes v and w respectively. However, exact path matching may not or cannot match paths (e.g., of EFLASK 320) with minor variations.

An approximate tree matching algorithm may produce a one-to-one matching M such that for any pair (v1, w1), (v2, w2) ϵ M: v1 is ancestor of v2 iff w1 is ancestor of w2 (Ancestor Condition) (Eqn. 2).

The output matching replaces the Path Condition in Eqn. 1 with another (potentially substantially weaker) Ancestor Condition (i.e., Path Condition implies Ancestor Condition). However, the algorithm is Max-SNP hard.

To reduce the running time, a Structure Respecting Condition to output matching is added to the tool. This algorithm produce a matching M, such that for any pairs (v1,w1), (v2,w2), (v3,w3) ϵ M: nca(v1,v2)=nca(v1,v3) iff nca(w1,w2)=nca(w1,w3) (Structure Respecting Condition) (Eqn. 3) where nca(x,y) is the nearest common ancestor of nodes x and y. Due to the additional constraint, fewer matching possibilities need to be considered, making the algorithm's running time a polynomial.

The above approximate algorithms may match EFLASKS 320 with very different call paths. In contrast to an exact path matching algorithm, which focuses on matching the path (component of EFLASKS 320) without considering the subtrees underneath, the above approximate matching algorithms match two nodes only based on a similarity of subtrees (another component of EFLASKS 320) underneath them disregarding the call paths. The EFLASK 320 matching algorithm proposed below leverages both the path and subtree information in matching two nodes, and in doing so, matches two EFLASKS 320.

### 3.4.3. EFLASK Matching Algorithm

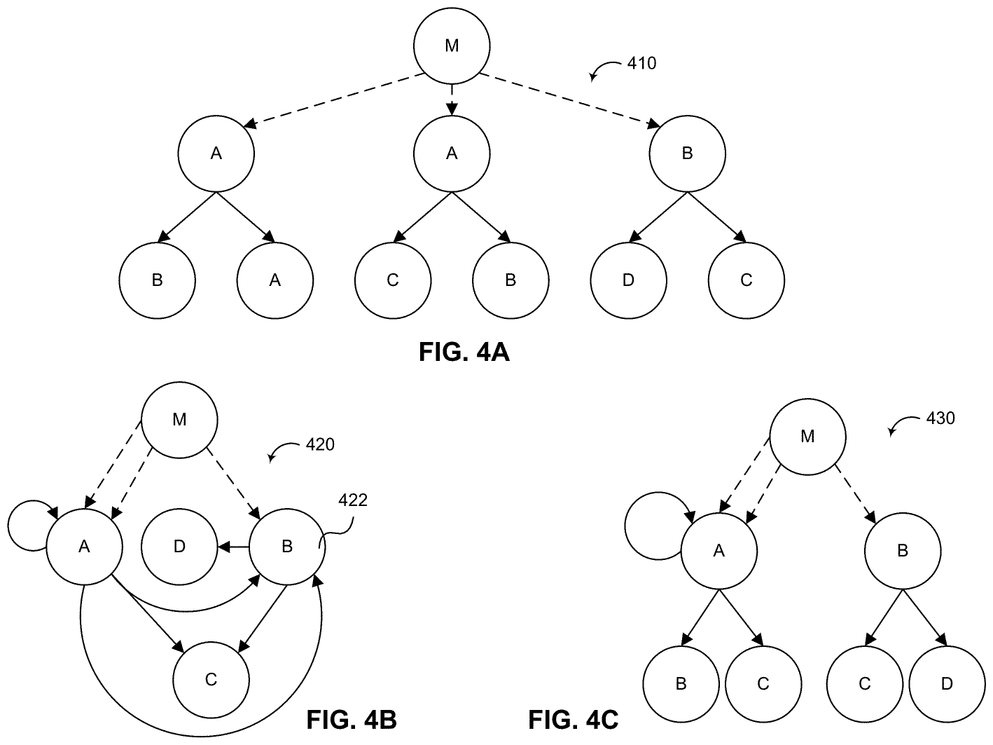

The EFLASK matching algorithm disclosed herein relaxes the Path Condition incrementally. To match two EFLASKS, the resource analyzer 144 determines whether a path in a first EFLASK differs from a path in a second EFLASK by less than a threshold number of methods. That is, paths from root to matched nodes in two trees can differ by at most a threshold a nodes, and maximizes the subtree overlap. The Path Condition in the exact matching algorithm is replaced with a Relaxed Path Condition while retaining the Structure Respecting Condition (Eqn. 3) and Ancestor Condition (Eqn. 2) to find such matching. Formally, a maximal one-to-one matching M is desired, satisfying Eqns. 2 and 3 and for any pair (v,w) ϵ M: w ϵ Cα (v) (Relaxed Path Condition) (Eqn. 4) where Cα (v)⊆V(T2) is the candidate set; the path of each node in Cα (v) from r2 differs from the path from r1 to v by less than or equal to α nodes. For example, FIG. 5 highlights the nodes in the candidate set Cα (b) for α equal to 0, 1 and 2. C0(b) 502 contains just 1 node that has the same path from its root as the b in T1. C1(b) 504 includes 3 additional nodes a, b and c whose path from the root becomes identical to b's from T1's root, r→a→b by doing exactly one operation—deleting b, deleting a and replacing b by c, respectively.

Before presenting embodiments of the disclosed algorithm, a few notations are defined. Let T1, T2 denote two unordered labeled trees with maximum degrees D1 and D2 respectively. The set of child nodes are denoted of node v by child(v) and its label by label(v). The path from root to node v thus forms a string of labels and is represented by s(v). Let q denote an empty tree and let T(v) denote the subtree of T rooted at a node v ϵ V(T) and F(v) denote the forest under node v, F(v)=T(v)−{v}.

While matching the nodes in two trees, one can perform three types of edit operations to the tree nodes: (1) a re-labeling operation to change the node label, (2) a deletion operation to delete node v and make all the children of v the children of P(v), and (3) an insertion operation, i.e., the complement of deletion.

Let λ denote a special blank symbol, then the cost of each edit operation is specified using a cost function, γ. Thus, γ (λ1, λ2) is the cost of replacing λ1 by λ2, γ (I1, λ) is the cost of deleting I1, and γ (I, λ1) is the cost of inserting I1. γ is generally assumed to be a distance metric, i.e., γ is non-negative, symmetric and follows triangular inequality. The notation is extended such that γ (v,w) for nodes v and w denotes γ (label(v), label(w)). A unit cost distance is in the design of algorithm, i.e., γ (I1, I2)=1 when I1≠I2. A few functions and their properties which form the basis of our algorithm are now defined.

Cα (v) is found by computing a path edit distance function ρ. For some v ϵ V(T1) and w ϵ V(T2), ρ(s(v), s(w)) is the total cost of edit operations required for v and w to have identical paths from the root. Thus, Cα (v)={w ϵ V(T2)|ρ(s(v), s(w))≤a}. Since paths s(v) and s(w) are strings, path edit distance function ρ(s(v), s(w)) is thus equal to the string edit distance between s(v) and s(w) and hence can be calculated in a similar manner. Because one may only care about path edit distance when it is less than or equal to α, some computation is pruned as soon as the distance exceeds α. It is shown that the runtime for computing Cα is O(min(N1D2a\hat{ }(α+2), N1N2)).

The disclosed embodiments include a subtree match function μα between two trees. For v ϵ V(T1) and w ϵ V(T2), μα (T1(v), T2(w)) is the size of maximal matching of subtrees T1(v) and T2(w) where matching nodes path differ by at-most α.

Before providing the next lemma, another definition is provided. A restricted matching RM(v,w) is a matching between nodes of F1(v) and F2(w) and is defined as follows. (1) RM(v,w) follows all the matching conditions—Relaxed Path Condition (Eqn. 4), Structure Respecting Condition (Eqn. 3), Ancestor Condition (Eqn. 2), and (2) if (p, q) is in RM(v,w), p is in T1(vi) and q is in T2(wj), then for any (p′, q′) in RM(v, w), p′ is in T1(vi) iff q′ is in T2(wj) where vi ϵ child(v) and wj ϵ child(w). In other words, the node from a subtree T1(vi) must only map to nodes of one subtree T2(wj) and vice versa.

The recurrence relationship for μα can be derived as follows.

$$Lemma 3.1 . For all v ∈ V ( T 1 ) and w ∈ V ( T 2 ) , \\ μ α ( T 1 ( v ) , θ ) = 0$$

$$μ α ( θ , T 2 ( w ) ) = 0 if$$

$$w ∉ C α ( v ) , μ α ( T 1 ( v ) , T 2 ( w ) ) = 0 otherwise , \\ μ α ( T 1 ( v ) , T 2 ( w ) ) = max ( \begin{matrix}max \\ wj ∈ child ( w )\end{matrix} μ α ( T 1 ( v ) , T 2 ( wj ) ) , \begin{matrix}max \\ wj ∈ child ( v )\end{matrix} μ α ( T 1 ( v ) , T 2 ( wj ) ) , \begin{matrix}max \\ RM ( v , w )\end{matrix} μ α ( RM ( v , w ) + ( 1 - y ( v , w ) ) ) ;$$

Again, for any v ϵ V(T1), μα (T1(v), T2(w)) can be computed for the function described above for all w Σ Cα(v). The runtime for computing μα is O(N1·min(D2\hat{ }(a+1), N2)·(D1+D2)·log(D1+D2))\hat{ }2.

In some embodiments, the EFLASK matching algorithm includes a flexible tree matching algorithm that takes two passes. The first pass is top-down to compute Cα (v) for all v ϵ V(T1). That is, the resource analyzer 144 finds nodes with call paths different by less than a threshold a number of nodes (i.e., methods). The second pass is bottom-up to compute μα (T1,T2), or the maximum size of a subtree where the call paths differ by less than the threshold number of nodes. Third, it uses a simple backtracking mechanism to find for each node v ϵ T1 the matching node w ϵ T2 that maximizes the T1-T2 tree match. Based on these matched nodes, the resource analyzer 144 identifies the corresponding EFLASKS as a match. The two passes together simultaneously accomplish matching of both call path and subtree components of similar EFLASKS.

### 3.5. Preprocessing CCTs to Facilitate Effective Matching

The α value affects the tradeoff between finding more matching tasks that vary in call paths and false positive matches. To make the algorithm more effective, several factors are identified that may increase the path distance between the paths for the same app task and pre-process the CCTs to remove such factors so that more matchings can be found with smaller α values.

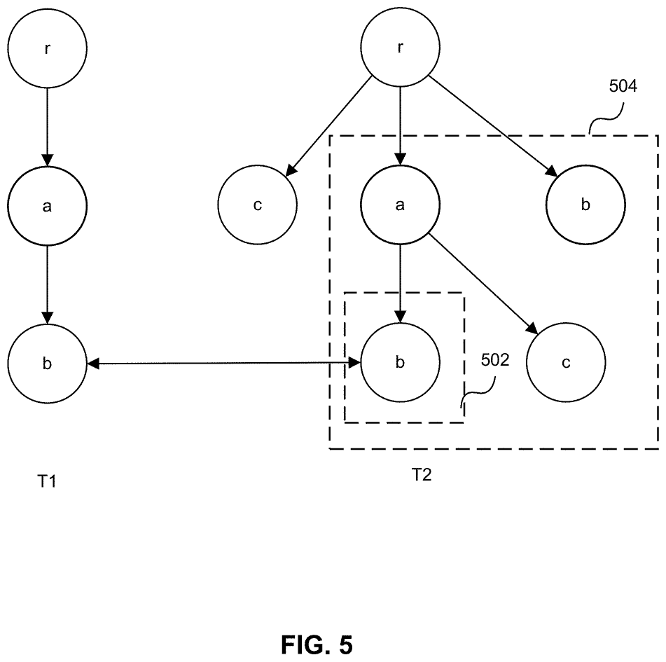

In some instances, there is an app namespace problem. The call paths for the same task in two CCTs can contain many app methods that are unique to each app as different developers are likely to structure and name the app methods differently. Such app-specific app methods can easily blow-up the path edit distance of the call paths of a matching task. FIG. 6(a, b) show an example of two paths with differing app methods.

In some instances, all the callback app methods override some predefined framework methods, and the remaining internal app methods called from other app methods have arbitrary names and are also often obfuscated. The internal app method calls are thus merged into the app callback method root node as shown in FIG. 6(c) and drop the app-specific class names from the app's callback node to allow matching callback methods.

Like using DCGs, merging app methods to address the app namespace problem can also reduce path sensitivity, but it improves the effectiveness of task matching as the internal methods of different apps tend to be named differently and thus path sensitivity to app method names harms path similarity matching.

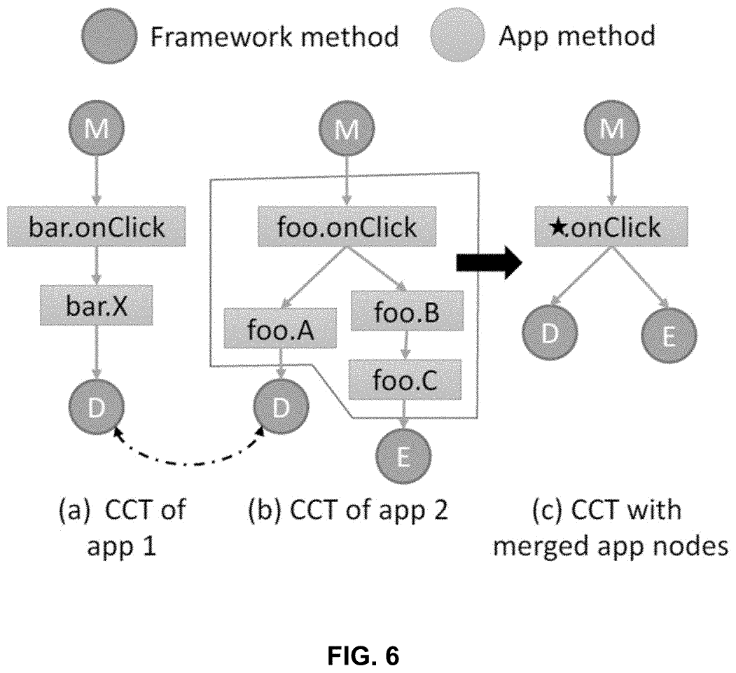

In some instances, there is a class hierarchy problem. Specifically, a similar issue arises due to the object-oriented nature of Java, as shown in the following example. The two apps in FIG. 7 share a same task pointed by the dashed arrow, but the first app uses method S.A which extends and calls method T.A and the second app directly uses T.A. Each such occurrence in the path increases the path edit distance by one, and more occurrences will quickly inflate the path edit distance.

This problem can be solved in two steps. First, T.A is merged into the caller S.A node. Second, the distance function γ is tweaked to allow matching S.A with T.A, i.e., g (S.A,T.A)=0. This allows matching the common task in FIG. 7(a)-7(b) with path distance of zero while retaining path edit distance for sibling classes in FIG. 7(c).

When considering F-method only paths, a third situation happens when a path off the root consists entirely of framework methods as discussed in § 3.2 (path (F0, F1) in FIG. 3). When this happens in energy profiling the energy consumption of the call path is not propagated to its asynchronous caller (i.e., the app task), which leaves the developer ignorant about app task caused the energy drain.

DIFFPROF 148 patches such asynchronous framework of only subtrees to its parent app task by adding additional logging in the ANDROID framework. In particular, it logs the callback object's .hashCode( ) along with the current timestamp and thread ID, when an asynchronous callback is enqueued in the framework and when the callback is later dispatched. During post-processing, for each dispatch method call, the nearest preceding enqueued method call with matching object .hashCode log is patched as the dispatch method call's asynchronous caller.

### 4. Implementation and Usage

In one example, DIFFPROF 148 is implemented on top of RPROF 146 with 5.7K lines of JAVA code. DIFFPROF 148 can be packaged as an IDE plugin that can be installed on a laptop, with a graphical user interface (GUI) front-end, for interacting with the developer and computing and showing the energy diff. RPROF 146 traces are collected on a mobile device running a modified ANDROID 6.0.1 framework version that adds 95 lines to capture hidden causal relationships due to asynchronous programming (§ 3.5).

After collecting RPROF 146 traces of two similar apps, the developer specifies these traces to DIFFPROF 148, and DIFFPROF 148 performs energy diffing in the following steps. (1) First, DIFFPROF 148 patches the call tree dumped by RPROF 146 by using the call timing and the log timestamp as described in § 3.5. (2) DIFFPROF 148 converts RPROF 146's CT result into CCT and outputs the CCT along with the inclusive and exclusive energy consumption by and the number of recursive and non-recursive invocations of each CCT node. (3) the developer is presented with a list of JAVA package names that appeared in either app trace to determine app packages used for merging app methods as described in § 3.5. By default, all packages not belonging to the ANDROID framework are marked as app packages. For comparing two different apps, developers can skip this step, since packages not belonging to the ANDROID framework are already marked as app packages. When comparing two versions of the app, however, this presents an opportunity for the developer to unmark certain app packages to expose app-internal path information (see FIG. 6) during matching. (4) DIFFPROF 148 performs the EFLASK 320 matching algorithm on the pair of CCTs. Finally, (5) since the EFLASKS 320 of multiple tasks may share a common path, DIFFPROF 148 assigns the energy drain for each task as the inclusive energy of the F-method.

In some embodiments, DIFFPROF 148 outputs: (1) a merged list of matched (app tasks with the other app) and unmatched app tasks, sorted by energy drain for unmatched tasks and energy difference for matched ones. That is, based on the potential room for improvement; and (2) upon selection, a task's EFLASK 320 is in a graphical view.

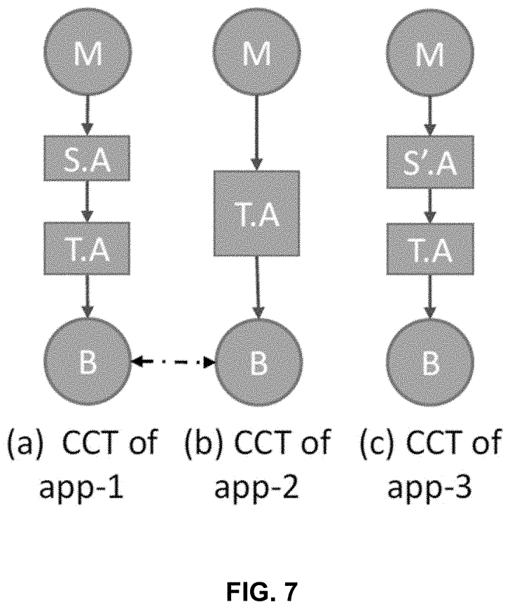

FIG. 8 is a flowchart illustrating a process for evaluating and improving app resource utilization, according to some embodiments. The process shown in FIG. 8 can be performed by the resource analyzer 144. In other embodiments, the process can include additional, fewer, or different steps, and the steps can be performed in different orders.

As shown in FIG. 8, the resource analyzer 144 matches, at step 802, a first application task (i.e., a first EFLASK) of a first mobile application to a second application task (i.e., a second EFLASK) of a second mobile application. The first and second mobile applications may be applications in the same app category. To match the app tasks, the resource analyzer 144 can generate a calling context tree for each application that defines relationships between methods associated with the first and second application tasks. A path in the calling context tree includes two or more consecutive methods causally called when the respective app is executed. In some embodiments, the resource analyzer 144 can match tasks if the resource analyzer 144 determines that a first path in the calling context tree associated with the first app task and a second path in the calling context tree associated with the second app task differ by less than a threshold number of methods.

At step 804, the resource analyzer 144 can cause the first and second mobile applications to perform an operation. The operation may be selected based on the category to which the apps belong. For example, the operation performed if the first and second apps are music streaming apps may include streaming music for a specified period of time, such as one minute.

At step 806, the resource analyzer 144 measures an amount of resource utilization when each of the first and second apps performs the operation. The resource analyzer 144 can then compare, at step 808, the energy drain associated with the matched tasks. For example, to measure an amount of energy drained by the apps, the resource analyzer 144 can measure the usage of all device components by the first and second applications and measure a correlation between power draw and usage of all device components offline. An energy drain for each application task can be calculated by integrating the power draw of each device component based on the usage of the application task, then adding together the energy drain for all device components used by the application task. As another example, to calculate an amount of processing resources used by the apps, the resource analyzer 144 can measure the processor usage for each method executed during an app task as a difference between a start time and a stop time of the method. The overall processor usage for the task can then be calculated by taking a sum of the processor usage of all methods associated with the task.

Responsive to determining the second mobile application consumes less energy than the first mobile application due to the second application task compared to the first application task, the resource analyzer 144 can perform, at step 810, an action to reduce energy consumption by the first mobile application. In various embodiments, the action may include issuing a notification indicating that the first application drains excessive energy, identifying the matched task of the first app, or automatically identifying inefficiencies in implementing the common app function in the first mobile app or the second mobile app.

### 5. Evaluation

Example uses of the resource analyzer 144, including how it helps developers with understanding and formulating a more efficient implementation, are now discussed.

### 5.1. Example Setup

By way of example, DIFFPROF 148 is configured for use to profile popular apps belonging to eight app categories. For each group, five different apps are picked and four older versions of one of the five apps. In running tests for this example, user interaction homogeneity is ensured by using automated testing as described in § 2.2.

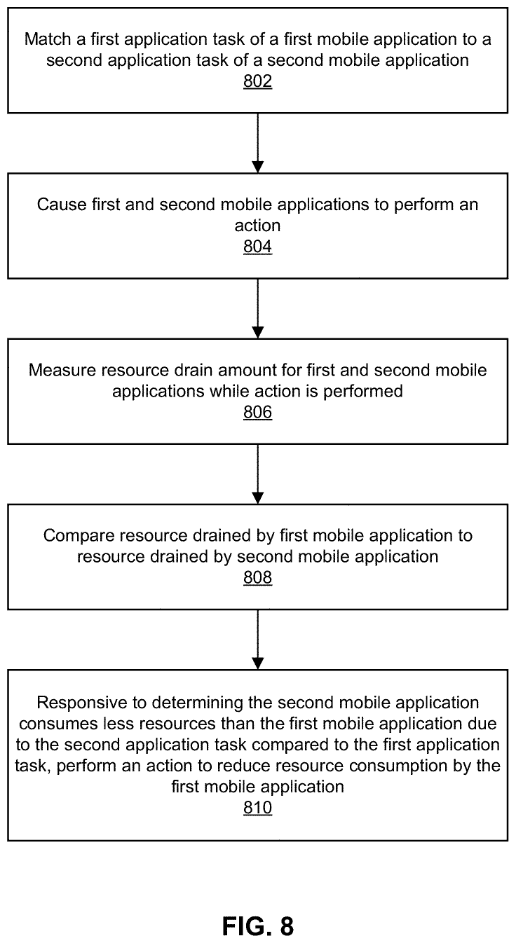

In some embodiments, the impact of a is considered. That is, the impact of changing a is evaluated on the EFLASK 320 matching algorithm's running time and output. Table 900 in FIG. 9 summarizes results of an example. As expected, the running time grows close to exponentially with a value (from 0 to 2 and from 2 to 4). On average, the algorithm in this example produces the energy diffing output within half a minute for all values of α≤5.

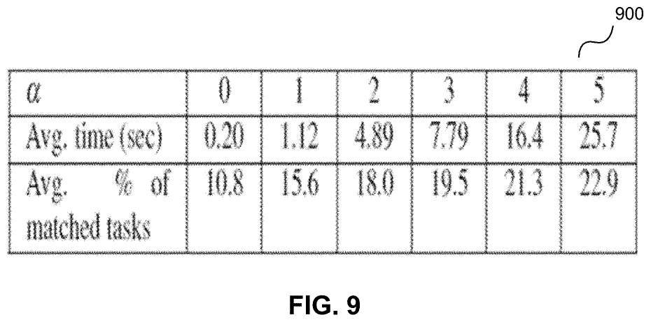

Notably the average percentage of matching tasks in some examples grows steadily as the value of a is increased, starting 10.8% on average at α=0 up to 22.9% at α=5. The growth slows down at α=5. Based on this result, when profiling the eight app groups for this example, for each app pair in a category, DIFFPROF 148 is run to find the matching tasks using the lowest a that can match 20% of the tasks, up to α=5 (shown as dynamic a in Table 1000 in FIG. 10).

5.2. Diffing Results

FIG. 2A-2E illustrates the pairwise task overlap for four app groups (Music streaming, Cleaning, Email, Launcher) are shown in the upper triangles. As shown, the task overlap between similar apps is significant, ranging between 7%-61%, with an average of 27%, 24%, 28%, and 17%, for the four groups, respectively.

Table 1000 in FIG. 10 shows example diffing results for each app in the eight app groups. For each app in the example, all its tasks are classified into tasks that could not be matched with any of the four other apps in its category and tasks that got matched with 4, 3, 2 or 1 other app(s). The columns under “Dynamic a” show that the count of such tasks for each app varies for different categories (e.g., Email apps have 17 5-way matching tasks while Music apps have only 2), suggesting the apps in different categories have different levels of overlapping tasks. No false positives were identified in the matched tasks that were examined.

Table 1000 also shows that the percentage of energy drained by matched tasks (i.e., 1 minus that of unique tasks energy) is, by way of example, over 70% of the total energy drained by the app for 32 out of the 40 apps. This suggests that although it is difficult to measure a coverage (false negative) of task matching produced by DIFFPROF 148, in practice, DIFFPROF 148 produces matched tasks that already account for a majority of the app energy drain. This gives app developers enough focus for optimization. DIFFPROF 148 also exposes app-unique tasks that drain significant amounts of energy. For example, Table 1000 shows that the example tests performed on the apps SOUNDCLOUD and CMLAUNCHER drain 53.7% and 43.7% of total energy when performing unique app tasks or features, waveform animation and rotation animation, respectively.

To show the effectiveness of the EFLASK 320 algorithm, the last column of Table 1000 lists the number of tasks in each app that do not get matched using exact path matching algorithm (α=0). The EFLASK 320 matching algorithm with dynamic a reduces the number of unmatched tasks by 13.5% on average (shown in the second column), in this example.

### 5.3. Effectiveness

DIFFPROF 148 provides developers with actionable diagnosis beyond a standard energy profiler in at least two ways: (1) DIFFPROF 148 identifies non-essential (i.e., unmatched or extra) and known inefficient (i.e., matched) tasks; (2) the EFLASKS 320 of tasks extracted by DIFFPROF 148 further expose the reasons for the more efficient implementation.

For convenience, in the following example, a task is referred to by the F-method in its EFLASK 320 3-tuple. An example of the methodology includes running DIFFPROF 148 on top three energy draining apps in each of the eight groups against the least energy-draining apps in the same groups, and looking at the top energy-draining app tasks output by DIFFPROF 148. 5.3.1. Unmatched (extra) tasks

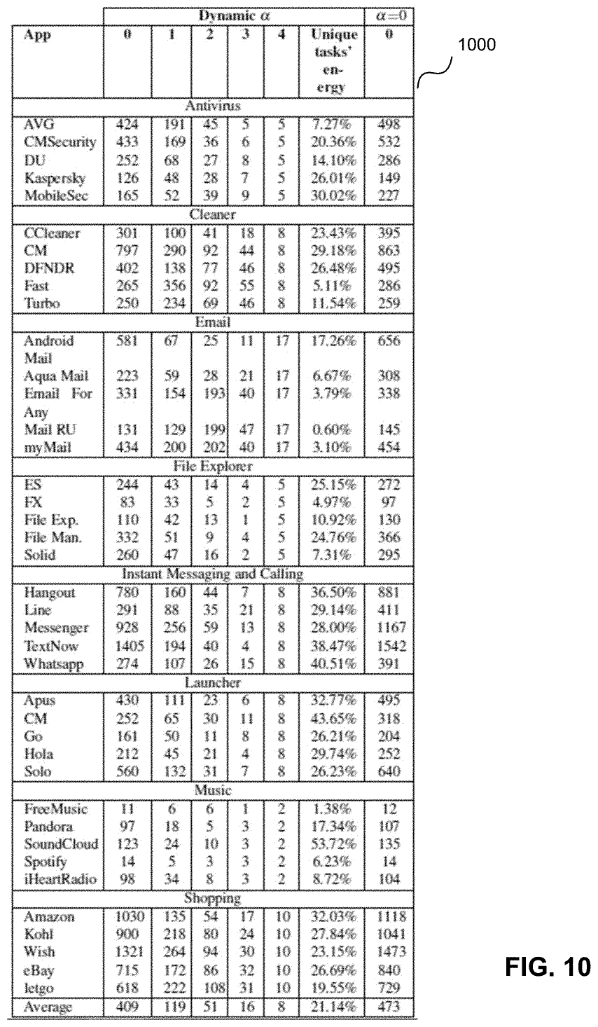

Table 1100 in FIG. 11 shows example energy output of one version of messaging app GOOGLE HANGOUTS compared with WHATSAPP, as determined by the resource analyzer 144. When sorted by inclusive energy, RPROF 146 shows high-level ANDROID methods such as Looper.loop on the top, and when sorted by exclusive energy, shows low-level ANDROID methods such as BinderProxy.transactNative. Such top energy drainers in both inclusive and exclusive energy lists are F-methods that do not directly call app methods and are not directly called by the app; developers thus do not get useful guidance on what to focus on from the long list of RPROF 146 output.

In contrast, DIFFPROF 148 can output tasks sorted by energy drain. It shows that GOOGLE HANGOUTS consumes more than 10% of its total energy in an unmatched task ContentResolver.query. Since F-methods of tasks are directly called by the app, the top task's name provides suggestions to developer on how to optimize the app. In contrast, RPROF 146 does not highlight such methods; the top task method appeared at position 27 when sorted by inclusive energy and at 1336 when sorted by exclusive energy.

Finding reasons and optimization for the task ContentResolver.query would have been easy for its developer from the EFLASK 320 output (e.g., the ContentResolver. query method was called 116 times). Given that the app was designed by a third party, to understand this energy drain, a breakpoint at ContentResolver.query method can be set and the app is re-run to examine the parameters passed to the method. In one call to the method, the app queries multiple fields that are stored in a local database.

In one example, it was found that at one message send, the app queries for 81 unique database fields which often get repeated across two different queries. Moreover, 36 fields of 81 do not change across two send key presses, such as author chat ID and author first name, but keep on getting queried at each send. This suggests that there is ample room for optimization by keeping a staleness flag; when the user navigates away from a chat window, the 36 fields can be declared stale and re-queried later.

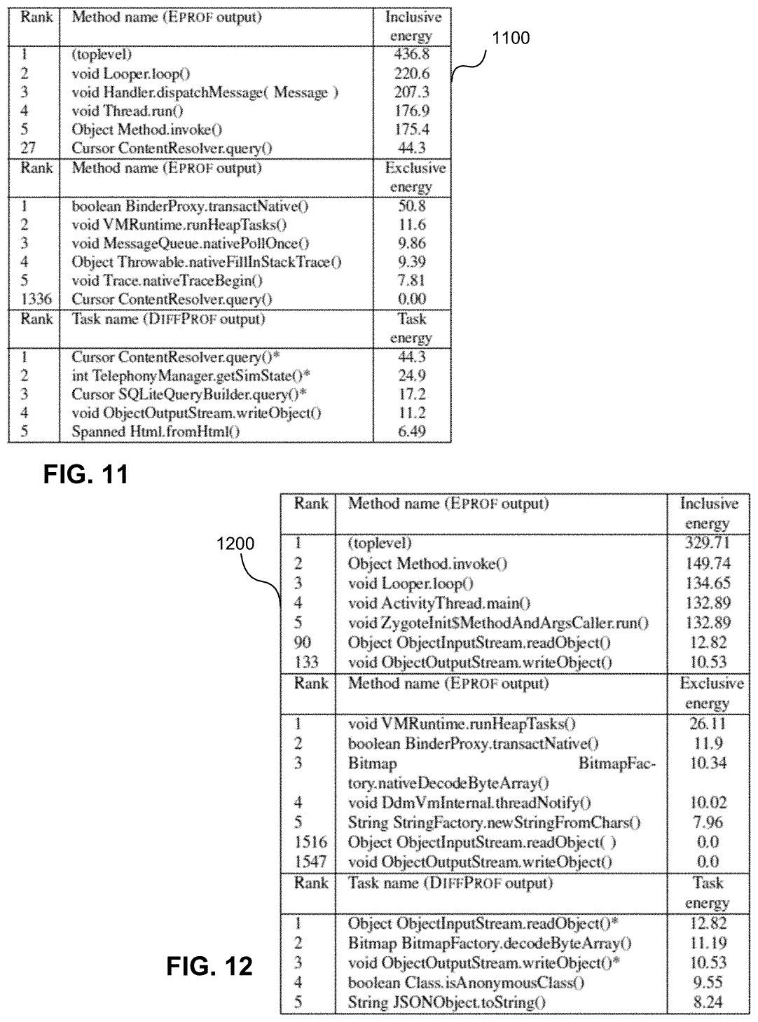

Table 1200 in FIG. 12 shows example energy output by a shopping app, KOHLS, compared with LETGO. DIFFPROF 148 shows ObjectInputStream.readObject and ObjectOutputStream.writeObject are two top energy draining extra tasks, consuming 3.9% and 3.2% of total energy consumption, respectively, in this example. In contrast, RPROF 146 outputs them at positions 90 and 133 when sorted by inclusive energy and at 1516 and 1547 when sorted by exclusive energy, respectively.

Because the app was written by a third party, analysis of the energy drain can be performed by setting breakpoints. In one example, it was found that the app keeps the entire catalog and current discount campaigns on the SD card in catalog.tmp and cms.tmp files respectively which were 227 KB and 21 KB at the time. Whenever a new catalog or a new campaign is synced with the server, the entire files are dumped again, rewriting the previous entries; using a database just to update new entries would be more efficient.

The task View.draw consumes 12.16 pAh of energy more than the above extra tasks but does not appear in the top task list. This is because can DIFFPROF 148 prioritize the tasks with the most room for optimization: since LETGO app consumes 8.29 pAh for the same task, the difference is less than 4 pAh.

This disclosure also considers music apps. In one example, DIFFPROF 148 can highlight an extra task in a music app that consumes 17.5% of the app's total energy drain. A developer can review this information to determine how to revise or restructure code in order to reduce power consumption by the app.

This disclosure also considers cleaner apps. In one example, DIFFPROF 148 shows that the DFNDR app calls framework method Runtime.exec, consuming 19.52 pAh, 5.2% of the app's total energy consumption (position 3 in DIFFPROF 148 output but 50 in RPROF 146 output).

In one example, a breakpoint is set at this method, the parameters are examined, and it was found that the app runs ps|grep <app pkg> for each app installed on the phone. Since ps walks down the entire/proc directory, it would be more efficient to obtain the ps output once and parse it to find the fields related to each app.

### 5.3.2. Matched Tasks

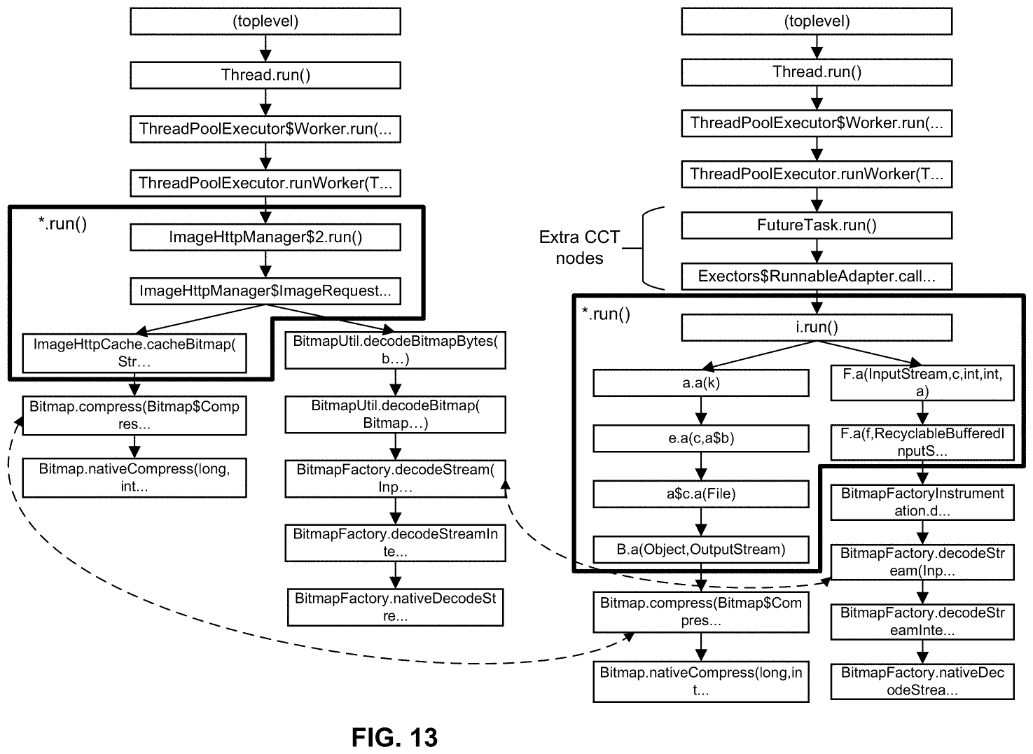

This disclosure also considers shopping apps for matched tasks. For example, in diffing WISH and LETGO, although the CCTs of the two apps differ a lot structurally as shown in FIG. 13, DIFFPROF 148 is able to match two commonstasks, Bitmap.compress and Bitmap-Factory.decodeStream, by collapsing app methods to *.run and its flexible EFLASK 320 matching algorithm.

For Bitmap.compress task, DIFFPROF 148 shows that the version of the WISH app tested in this example consumes 100.94 pAh, 15.9% of its total energy drain whereas LETGO consumes only 7.14 pAh. To find the root cause of energy difference, the parameters passed to the F-method were examined by setting a breakpoint and rerunning both apps. It was found that WISH compresses the image into a png image with quality set to 100 while LETGO compresses into a jpg image with quality set to 90. This causes the large energy difference while images shown by both apps are visually similar. The aforementioned difference in image format also explains the energy drain difference between second common task BitmapFactory.decodeStream where WISH consumes 126.32 pAh, 19.9% of total energy drain while LETGO consumes only 5.01 pAh.

This disclosure also considers different versions of the same app. In one example, different versions of the PANDORA music app were considered. In diffing two versions of PANDORA, DIFFPROF 148 matches a common task even though structurally their EFLASKS 320 appear different. DIFFPROF 148 shows that the common task consumes 43.63 pAh, 28.1% of its total energy consumption in PANDORA v5.7 but only 0.74 pAh in the latest PANDORA app, v8.3. DIFFPROF 148 further highlights the reason for the difference: in PANDORA v5.7, the subtree additionally contains the ViewRootImpl.scheduleTraversal subtree that traverses and measures the entire view hierarchy. In one example, a premium account was used to disable ads and played the same radio station on both PANDORA versions for two hours while leaving the phone on the playback screen. It was found that PANDORA v5.7 drained 9.2% battery per hour whereas PANDORA v8.3 drained only 6.7% of battery per hour.

This disclosure also considers music apps for matched tasks. In diffing PANDORA and SPOTIFY apps, DIFFPROF 148 shows that the common Progress-Bar.setProgress task consumes 43.63 pAh, 28.1% of total energy in SPOTIFY, but just 1.74 pAh in PANDORA. The EFLASK 320 output further shows that SPOTIFY calls this method fromApp.doFrame 596 times while PANDORA calls it only 29 times from App.onTrackElapsedTime during the 30 second music playback, while PANDORA updates the progress bar once per second, SPOTIFY updates it on every frame, which is unnecessarily frequent as many frames draw lead to no pixel change.

In diffing instant messaging apps such as TEXTNOW and WHATSAPP, DIFFPROF 148 shows that TEXTNOW consumes 230.46 pAh, 40.6% of total energy drain in calling common task ViewRootImpl.performTraversal, which is almost 10 times that in WHATSAPP. On inspecting the layout of the two apps with ANDROID's HierarchyViewer, it was found that TEXTNOW contains 226 views compared to just 76 views in WHATSAPP. Upon closer inspection of view properties, it was found that 172 views are in fact not visible on the screen. The app statically loads all the possible UI interactions such as pause playing voice note button, change billing details button icon keeping them all in the view hierarchy instead of dynamically loading views on demand as recommended by ANDROID thus inflating the view hierarchy traversal energy. Moreover, the app contains several LinearLayout with just an ImageView and a TextView which are recommended to be compressed into one compound view to further reduce the size of view hierarchy.

In diffing file explorer apps, DIFFPROF 148 shows that SOLID explorer consumes 35.52 pAh, 18.9% of total energy in the task Drawable.invalidateSelf whereas FX FILE explorer only consumes 1.24 pAh. DIFFPROF 148 further shows that SOLID calls Drawable.invalidateSelf 1002 more times than FX and that the EFLASK 320 contains ObjectAnimator.animateValue followed by SOLID'S CircularAnimatedDrawable$1.set. Upon inspecting this class, it was found that the app does the animation when a new folder is created. At each frame, an arc is drawn and requests another frame. However, after the folder gets created, the app stops drawing the arc but keeps requesting new frames, unnecessarily wasting energy.

### Remarks

The effectiveness of DIFFPROF 148 in finding energy optimizations stems from the large overlap of ANDROID libraries used among competing ANDROID apps and accurate source-level energy profiling. As such, the central idea of diffing source-code-level profiling of similar apps can be extended to find optimization opportunities in other performance metrics of interests to developers, such as latency, scalability and memory efficiency.

One of the central principles of software engineering, DRY (Don't repeat yourself), preaches the use of reusable code, by abstracting all common reusable code into standalone libraries. The principle improves modern software developer productivity and has gained wide adoption in recent years; almost every major build tool today allows developers to specify library dependencies which are downloaded from a central repository and packaged with the software. DIFFPROF 148's approach may be extended to effectively compare source-code level profiling measurements of software in broader domains beyond mobile such as games, web frontends, and server backends.

Performance and energy profiling are further considered. DIFFPROF 148 tackles the challenging but critical question in the app energy optimization process: whether and how energy hotspots in app source code can be restructured to drain less energy.

This disclosure presents embodiments that tackle differential energy profiling, which involves the challenging but critical question in an app energy optimization process faced by app developers. That is, whether and how energy hotspots in app source code can be restructured to drain less energy. By performing approximate matching of energy profiles of similar apps by a traditional energy profiler, energy diffing automatically uncovers more efficient implementations of common app tasks and app-unique tasks among similar apps. This disclosure shows how the DIFFPROF 148 tool provides developers with actionable diagnosis beyond a traditional energy profiler. For example, it effortlessly reveals twelve inefficient or buggy implementations in nine apps, and it further allows non-developers to quickly understand reasons and fixes for the energy difference.

### Example Computing Device

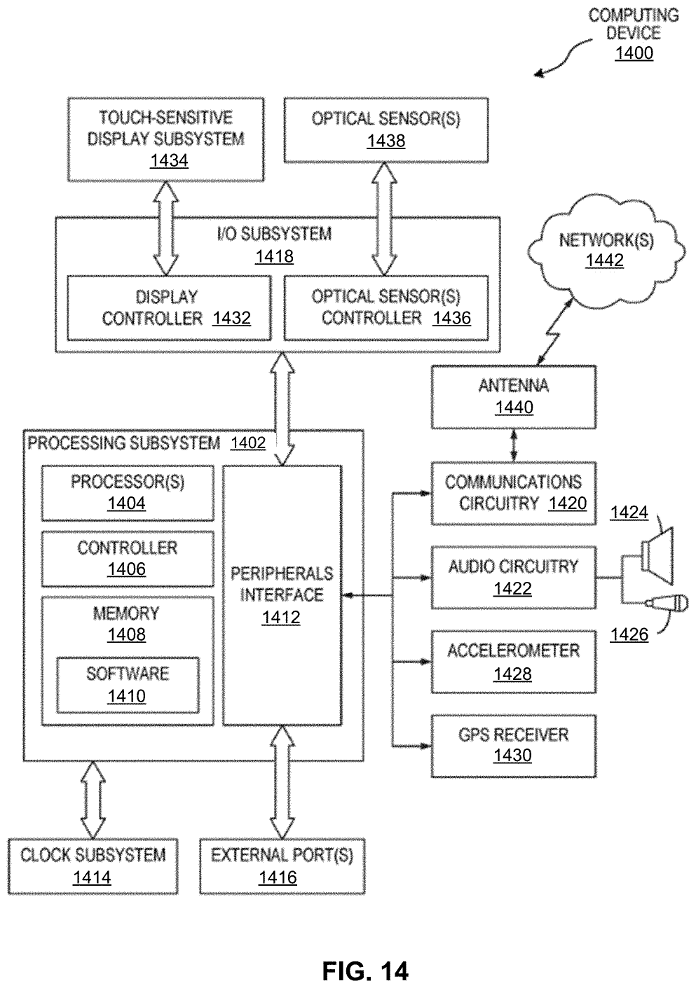

FIG. 14 is a block diagram illustrating an example computing device (e.g., a smartphone) in which aspects of the disclosed technology can be embodied. The computing device 1400 may include generic components and/or components specifically designed to carry out the disclosed technology. The computing device 1400 may be a standalone device or part of a distributed system that spans networks, locations, machines, or combinations thereof. For example, components of the computing device 1400 may be included in or coupled to a system-on-chip (SOC), a single-board computer (SBC) system, a desktop or laptop computer, a kiosk, a mainframe, a mesh of computer systems, or combinations thereof.

In some embodiments, the computing device 1400 can operate as a server device or a client device in a client-server network environment, or as a peer machine in a peer-to-peer system. In some embodiments, the computing device 1400 may perform one or more steps of the disclosed embodiments in real-time, near real-time, offline, by batch processing, or combinations thereof.

The computing device 1400 includes a processing subsystem 1402 that includes one or more processors 1404 (e.g., central processing units (CPUs), application specific integrated circuits (ASICs), and/or field programmable gate arrays (FPGAs)), a memory controller 1406, memory 1408 that can store software 1410, and a peripherals interface 1412. The memory 1408 may include volatile memory (e.g., random-access memory (RAM)) and/or non-volatile memory (e.g., read-only memory (ROM)). The memory 1408 can be local, remote, or distributed. The computing device 1400 can also include a clock subsystem 1414 that controls a timer for use in some embodiments. The components of the computing device 1400 are interconnected over a bus (not shown) operable to transfer data between hardware components.

The peripherals interface 1412 is coupled to one or more external ports 1416 which can connect to an external power source, for example. The peripherals interface 1412 is also coupled to an I/O subsystem 1418. Other components coupled to the peripherals interface 1412 include communications circuitry 1420, audio circuitry 1422 for a speaker 1424 and a microphone 1426, an accelerometer 1428, a GPS receiver 1430 (or global navigation satellite system (GLONASS) or other global navigation system receiver), and other sensors (not shown). The GPS receiver 1430 is operable to receive signals concerning the geographic location of the computing device 1400. The accelerometer 1428 can be operable to obtain information concerning the orientation (e.g., portrait or landscape) of the computing device 1400.

The I/O subsystem 1418 includes a display controller 1432 operative to control a touch-sensitive display system 1434, which further includes the touch-sensitive display of the computing device 1400. The I/O subsystem 1418 also includes an optical sensor(s) controller 1436 for one or more optical sensors 1438 of the computing device 1400. The I/O subsystem 1418 includes other components (not shown) to control physical buttons.

The communications circuitry 1420 can configure the antenna 1440 of the computing device 1400. In some embodiments, the antenna 1440 is structurally integrated with the computing device 1400 (e.g., embedded in the housing or display screen) or coupled to the computing device 12 through the external ports 1416. The communications circuitry 1420 can convert electrical signals to/from electromagnetic signals that are communicated by the antenna 1440 to networks 1442 (e.g., network 208 of FIG. 2A-2E) or other devices. For example, the communications circuitry 1420 can include radio frequency (RF) circuitry that processes RF signals communicated by the antenna 1440.

The communications circuitry 1420 can include circuitry for performing well-known functions such as an RF transceiver, one or more amplifiers, a tuner, oscillators, a digital signal processor, a CODEC chipset, a subscriber identity module (SIM card or eSIM), and so forth. The communications circuitry 1420 may communicate wirelessly via the antenna 1440 with the networks 1442 (e.g., the Internet, an intranet and/or a wireless network, such as a cellular network, a wireless local area network (LAN) and/or a metropolitan area network (MAN)) or other devices.

The software 1410 can include an OS software program, application software programs, and/or modules. For example, a GPS module can determine the location of the computing device 1400 based on the GPS signals received by the GPS receiver 1430. The GPS module can provide this information to components of the computing device 1400 for use in various applications (e.g., to provide location-based contextual information).

A software program, when referred to as “implemented in a computer-readable storage medium,” includes computer-readable instructions stored in the memory (e.g., memory 1408). A processor (e.g., processor 1404) is “configured to execute a software program” when at least one value associated with the software program is stored in a register that is readable by the processor. In some embodiments, routines executed to implement the disclosed embodiments may be implemented as part of OS software (e.g., Microsoft Windows and Linux) or a specific software application, component, program, object, module, or sequence of instructions referred to as “computer programs.”

Computer programs typically comprise one or more instructions set at various times in various memory devices of the computing device 1400, which, when read and executed by the processor 1404, will cause the computing device 1400 to execute functions involving the disclosed embodiments. In some embodiments, a carrier containing the aforementioned computer program product is provided. The carrier is one of an electronic signal, an optical signal, a radio signal, or a non-transitory computer-readable storage medium (e.g., the memory 1408).

Operation of the memory 1408, such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

The computing device 1400 may include other components that are not shown nor further discussed herein for the sake of brevity. One having ordinary skill in the art will understand any hardware and software that is included but not shown in FIG. 14. While embodiments have been described in the context of fully functioning computing devices, those skilled in the art will appreciate that the various embodiments are capable of being distributed as a program product in a variety of forms and that the disclosure applies equally, regardless of the particular type of machine or computer-readable media used to actually effect the embodiments.

Remarks

The foregoing description of various embodiments of the disclosed subject matter has been provided for the purposes of illustration and description. It is not intended to be exhaustive or to limit the disclosed subject matter to the precise forms disclosed. Many modifications and variations will be apparent to one skilled in the art. Embodiments were chosen and described in order to best describe the principles of the invention and its practical applications, thereby enabling those skilled in the relevant art to understand the disclosed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by this disclosure. Particular terminology used when describing certain features or aspects of various embodiments should not be taken to imply that the terminology is being redefined herein to be restricted to any specific characteristics, features, or aspects of the technology with which that terminology is associated. In general, the terms used in the following embodiments should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

1. A method comprising:
matching, by a processor, a first application task of a first application to a second application task of a second application based on a determination that the first application task is similar to the second application task;
causing, by the processor, the first application and the second application to perform an operation;
while the first application and second application perform the operation, measuring, by the processor, a resource usage for each of the first application and the second application spent in the first application task and the second application task respectively; and
responsive to determining that the second application consumes fewer resources in the second application task compared to the resource usage by the first application in the first application task, performing, by the processor, an action to reduce the resource usage by the first application based on the second application task.

2. The method of claim 1, further comprising determining, by the processor, the first application task is similar to the second application task by generating a calling context tree for each of the first application and the second application, the calling context tree defining relationship between methods called during execution of a corresponding application.

3. The method of claim 2, wherein the first application task and the second application task each include a tuple defining a call path, a framework method, and a subtree in the corresponding calling context trees, where the framework method is from the stack of code that is common to both applications such as support programs, libraries, tool sets, and Application Programming Interfaces (APIs).

4. The method of claim 3, wherein a path in a calling context tree comprises two or more methods causally called during execution of the corresponding application, wherein a subtree in a calling context tree comprises a set of methods called by a method during execution of the corresponding application, and wherein determining the first application task is similar to the second application task comprises:
identifying a first path from a root to a framework method in the calling context tree associated with the first application task, and a second path from a root to a framework method in the calling context tree associated with the second application task that differ by less than a threshold number of methods, and
Identifying a first subtree under the framework method in the calling context tree associated with the first application task and a second subtree under the framework method in the calling context tree associated with the second application task that have a maximal number of matched methods, wherein paths from corresponding roots of two matched methods differ by less than the threshold number of methods.

5. The method of claim 1, wherein the resource consumed is an amount of energy drain by the first and second applications, and wherein measuring the energy drain amount for an application task in the first application comprises:
measuring an amount of energy drained by all device components by the application task;
measuring a correlation between the amount of energy drained and usage of all device components offline; and
determining the energy drain amount for the application task by deriving an energy drain of each device component by calculating at integrating of a power draw of the device component based on the usage of the application task, and summing up the calculated power draws by all device components used by the application task.

6. The method of claim 1, wherein the resource consumed is an amount of processor usage by the first and second applications, and wherein measuring the processor usage amount for an application task in the first application comprises:
measuring for each method executed by the application task, processor usage amount for the method by calculating a difference between a start time and a stop time of the method; and
determining the processor usage amount for the application task by summing up the processor usage amounts of all the methods executed by the application task.

7. The method of claim 1, wherein the first application is in a same application category as the second application.

8. The method of claim 1, wherein the first application and second application are different versions of an app.

9. The method of claim 1, wherein performing the action comprises:
issuing a notification indicating that the first application uses excessive resources.

10. The method of claim 9, wherein the notification indicates that the first application task uses more resources than the second application task.

11. The method of claim 9, wherein the notification indicates that the first application task is configurable to use fewer resources by reimplementing the first application task of the first application based on the second application task in the second application.

12. The method of claim 1, wherein the first application task and second application task implement a common functionality.

13. The method of claim 11, wherein performing the action comprises:
automatically identifying inefficiencies in implementing the common functionality in the first application or the second application.

14. A non-transitory computer readable storage medium storing computer program instructions, the computer program instructions when executed by a processor causing the processor to:
match a first application task of a first application to a second application task of a second application based on a determination that the first application task is similar to the second application task;
while each of the first application and second application perform an operation, measure a resource usage for each of the first application and the second application spent in the first application task and the second application task respectively; and
perform an action to reduce the resource usage by the first application based on the second application task.

15. The non-transitory computer readable storage medium of claim 14, wherein the computer program instructions when executed further cause the processor to determine the first application task is similar to the second application task by comparing a calling context tree for each of the first application task and the second application task, the calling context tree defining relationships between methods called during execution of a corresponding application.

16. The non-transitory computer-readable storage medium of claim 14, wherein a path in a calling context tree comprises two or more methods causally called during execution of the corresponding application, wherein a subtree in a calling context tree comprises a set of methods called by a method during execution of the corresponding application, and wherein determining the first application task is similar to the second application task comprises:
identifying a first path from a root to a framework method in the calling context tree associated with the first application task, and a second path from a root to a framework method in the calling context tree associated with the second application task that differ by less than a threshold number of methods, and
Identifying a first subtree under the framework method in the calling context tree associated with the first application task and a second subtree under the framework method in the calling context tree associated with the second application task that have a maximal number of matched methods, wherein paths from corresponding roots of two matched methods differ by less than the threshold number of methods.

17. The non-transitory computer-readable storage medium of claim 14, wherein the resource consumed is an amount of energy drain by the first and second applications, and wherein measuring the energy drain amount for an application task in the first application comprises:
measuring an amount of energy drained by all device components by the application task;
measuring a correlation between the amount of energy drained and usage of all device components offline; and
determining the energy drain amount for the application task by deriving an energy drain of each device component by calculating at integrating of a power draw of the device component based on the usage of the application task, and summing up the calculated power draws by all device components used by the application task.

18. The non-transitory computer-readable storage medium of claim 14, wherein the resource consumed is an amount of processor usage by the first and second applications, and wherein measuring the processor usage amount for an application task in the first application comprises:
measuring for each method executed by the application task, processor usage amount for the method by calculating a difference between a start time and a stop time of the method; and
determining the processor usage amount for the application task by summing up the processor usage amounts of all the methods executed by the application task.

19. The non-transitory computer readable storage medium of claim 14, wherein performing the action comprises:
issuing a notification indicating that the first application uses excessive resources.

20. The non-transitory computer readable storage medium of claim 19, wherein the notification indicates that the first application task is configurable to use fewer resources by reimplementing the first application task of the first application based on the second application task in the second application.
